(19) United States
(12) Patent Application Publication
(10) Pub. No.: US 2011/0299277 A1
(43) Pub. Date: Dec. 8, 2011

(54) ILLUMINATING APPARATUS AND METHOD OF CONTROLLING ILLUMINATING APPARATUS

(75) Inventor: Toshihiro EHARA, Niiza-shi (JP)

(73) Assignee: Sanken Electric Co., Ltd., Niiza-shi (JP)

(21) Appl. No.: 13/108,275

(22) Filed: May 16, 2011

(30) Foreign Application Priority Data
Jun. 7, 2010 (JP) 2010-130140

(51) Int. Cl. F21V 9/00

(52) U.S. Cl. 362/231

(57) ABSTRACT

An illuminating apparatus 1 includes a first light source 10 to output white light, having a first light emitting diode 11 to emit blue light and a first phosphor layer 12 containing blue excited phosphors M1 that emit light when excited by the blue light from the first light emitting diode 11 and a second light source 20 to output white light, having a second light emitting diode 21 to emit blue light, a second phosphor layer 22 containing blue excited phosphors M2 that emit light when excited by the blue light from the second light emitting diode 21, and a filter layer 23 to partly block blue light that is emitted from the second light emitting diode 21 and is transmitted through the second phosphor layer 22.

### BACKGROUND OF THE INVENTION

1. Field of the Invention

The present invention relates to an illuminating apparatus that employs light emitting diodes (LEDs) as a light source and takes into account an influence on a human biological rhythm and to a method of controlling such an illuminating apparatus.

2. Description of Related Art

There are illuminating apparatuses that employ LEDs as light sources. Among such apparatuses, a white-light illuminating apparatus is realized by an RGB configuration using red, green, and blue LEDs, or by a pseudo-white LED that is a combination of a blue LED and blue excited phosphors that emit yellow, green, and red light when excited by blue light.

There is an LED illuminating apparatus that takes an influence on a human biological rhythm into account. An example of this type of apparatus employs red LEDs, green LEDs, and two kinds of blue LEDs having different wavelengths. The apparatus controls the two kinds of blue LEDs in such a way as to control the melatonin secretion of a human body. This technique is disclosed in, for example, Japanese Unexamined Patent Application Publication No . 2007-173557.

### SUMMARY OF THE INVENTION

The white-light illuminating apparatus of the RGB configuration employing red, green, and blue LEDs has a difficulty in securing the evenness and controllability of chromaticity, brightness, and color, and therefore, involves low productivity, high cost, and low power efficiency because it must drive many LEDs.

The present invention provides an illuminating apparatus capable of controlling the melatonin secretion of a human body and securing power efficiency, as well as a method of controlling such an illuminating apparatus.

According to an aspect of the present invention, the illuminating apparatus includes a first light source and a second light source. The first light source is configured to output white light and has a first light emitting diode to emit blue light and a first phosphor layer containing blue excited phosphors that emit light when excited by the blue light from the first light emitting diode. The second light source is configured to output white light and has a second light emitting diode to emit blue light, a second phosphor layer containing blue excited phosphors that emit light when excited by the blue light from the second light emitting diode, and a filter layer to partly block blue light that is emitted from the second light emitting diode and is transmitted through the second phosphor layer.

According to another aspect of the present invention, the method controls an illuminating apparatus that includes a first light source configured to output white light and having a first light emitting diode to emit blue light and a first phosphor layer containing blue excited phosphors that emit light when excited by the blue light from the first light emitting diode and a second light source configured to output white light and having a second light emitting diode to emit blue light, a second phosphor layer containing blue excited phosphors that emit light when excited by the blue light from the second light emitting diode, and a filter layer to partly block blue light that is emitted from the second light emitting diode and is transmitted through the second phosphor layer. The method includes controlling the first and second light sources such that, when the brightness of output light from one of the first and second light sources is increased, the brightness of output light from the other is decreased.

### BRIEF DESCRIPTION OF THE DRAWINGS

FIG. 1 is a schematic view illustrating an illuminating apparatus according to a first embodiment of the present invention;

FIG. 2 is a table listing phosphors applicable to the illuminating apparatus according to the first embodiment;

FIG. 3 is a graph illustrating the emission spectrum characteristics of an incandescent bulb, a fluorescent lamp, and a pseudo-white LED;

FIG. 4 is a graph illustrating an example of temporally changing the brightness of output light from the illuminating apparatus according to the first embodiment;

FIG. 5 is a top view illustrating an example of arrangement of first and second light sources in the illuminating apparatus according to the first embodiment;

FIG. 6 is a top view illustrating another example of arrangement of first and second light sources in the illuminating apparatus according to the first embodiment;

FIG. 7 is a schematic view illustrating an illuminating apparatus according to a second embodiment of the present invention;

FIG. 8A is a top view illustrating an illuminating apparatus according to a modification of the second embodiment of the present invention;

FIG. 8B is a sectional view taken along a line VIII-VIII of FIG. 8A;

FIG. 9A is a top view illustrating an illuminating apparatus according to another modification of the second embodiment of the present invention; and

FIG. 9B is a sectional view taken along a line IX-IX of FIG. 9A.

### DESCRIPTION OF PREFERRED EMBODIMENTS

The first and second embodiments of the present invention will be explained with reference to the drawings. Through the drawings, the same or like parts are represented with the same or like reference marks. The drawings are schematic, and therefore, the dimensions of components illustrated in the drawings must be assessed based on the explanation mentioned below. Among the components illustrated in the drawings, dimensional relationships and proportions are not always coordinated.

The first and second embodiments mentioned below present examples of apparatuses and methods that embody a technical idea of the present invention. The present invention is not limited to the shapes, structures, arrangements, and the like mentioned below. The embodiments and modifications allow various changes to be made within the scope of claims of the present invention.

### First Embodiment

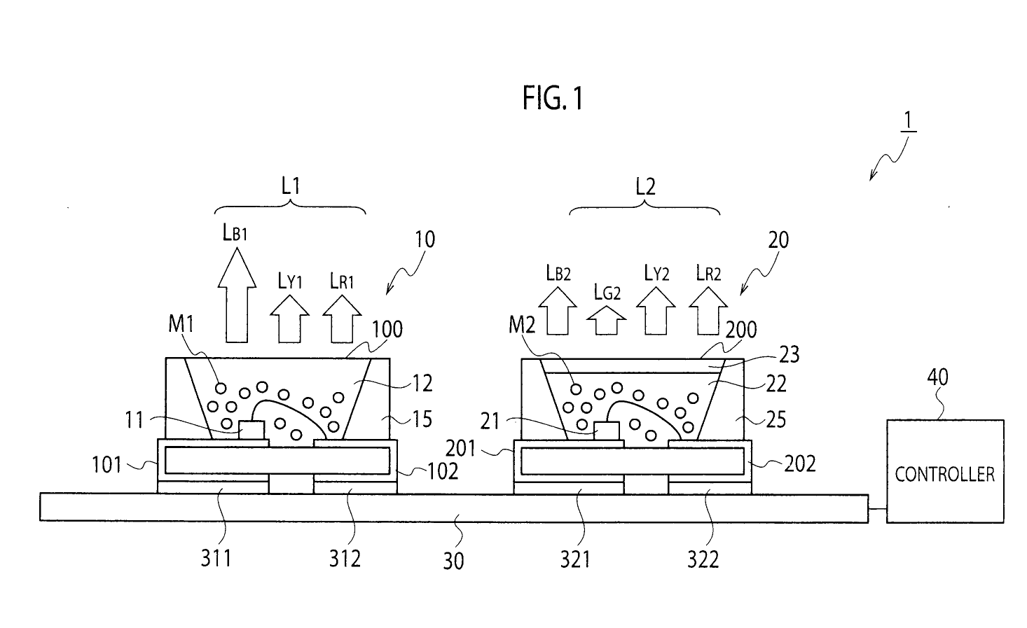

FIG. 1 illustrates an illuminating apparatus according to the first embodiment of the present invention. The illuminating apparatus 1 includes a first light source 10 and a second light source 20. The first light source 10 includes a first LED (light emitting diode) 11 to emit blue light and a first phosphor layer 12 containing blue excited phosphors M1 to emit light when excited by the blue light from the first LED 11. The first light source 10 consequently outputs white light. The second light source 20 includes a second LED 21 to emit blue light, a second phosphor layer 22 containing blue excited phosphors M2 to emit light when excited by the blue light from the second LED 21, and a filter layer 23 to partly block blue light that is emitted from the second LED 21 and transmitted through the second phosphor layer 22. The second light source 20 consequently outputs white light. The first and second light sources 10 and 20 each are a pseudo-white LED formed by combining a blue LED and various kinds of blue excited phosphors.

The first and second light sources 10 and 20 are arranged on a board 30. The first and second LEDs 11 and 21 each have a bottom face serving as a negative electrode and a top face serving as a positive electrode, to emit blue light from the top face.

The negative electrode of the first LED 11 is connected to a negative electrode 101 and the positive electrode of the first LED 11 is connected through, for example, a bonding wire to a positive electrode 102. The negative electrode 101 is connected to wiring 311 arranged on the board 30 and the positive electrode 102 is connected to wiring 312 arranged on the board 30. Between the positive and negative electrodes of the first LED 11, a voltage is applied through the wiring 311 and 312, to provide a drive current to the first LED 11, which then emits blue light.

The second LED 21 is constituted like the first LED 11. The negative electrode of the second LED 21 is in contact with a negative electrode 201 and the positive electrode thereof is connected through, for example, a bonding wire to a positive electrode 202. The negative electrode 201 is connected to wiring 321 arranged on the board 30 and the positive electrode 202 is connected to wiring 322 arranged on the board 30. Between the positive and negative electrodes of the second LED 21, a voltage is applied through the wiring 321 and 322, to provide a drive current to the second LED 21, which then emits blue light.

The first and second light sources 10 and 20 have packages 15 and 25, respectively. The package 15 (25) has a concave space whose top is wider than whose bottom. The concave space is filled with the first phosphor layer 12 (second phosphor layer 22), and at the bottom of the concave space, the first LED 11 (second LED 21) is arranged. This configuration improves the directivity of blue light emitted from the first LED 11 (second LED 21).

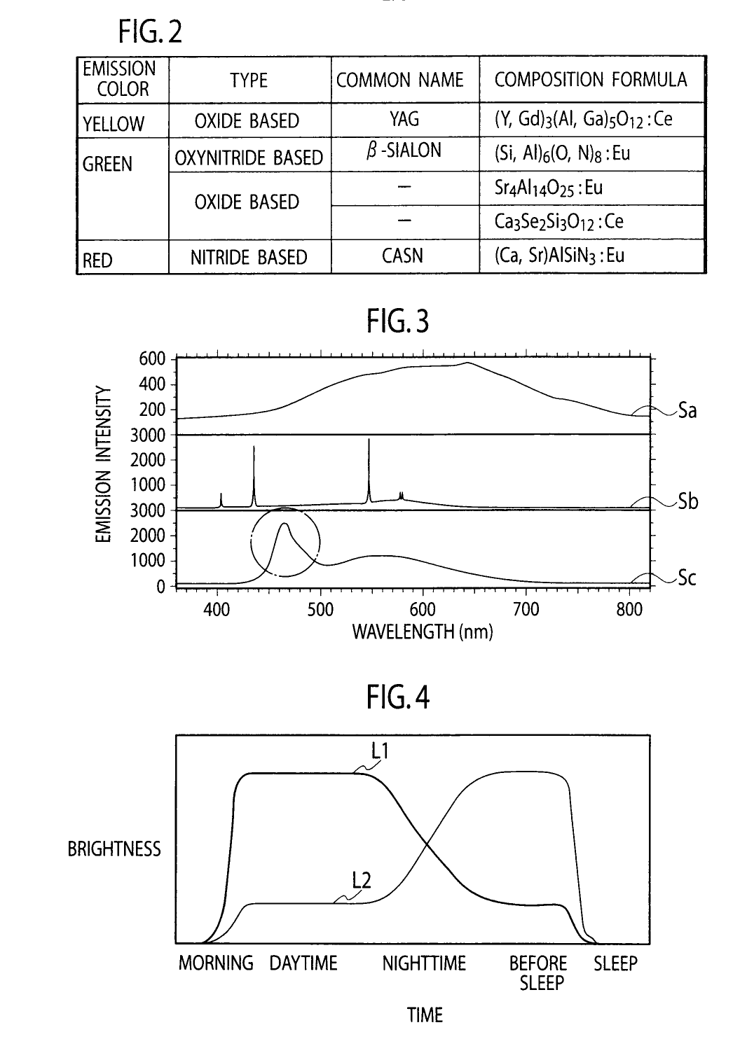

The blue light emitted from the first LED 11 passes through the first phosphor layer 12 and is outputted from an output face 100 of the first light source 10. The first phosphor layer 12 may be made of resin containing the blue excited phosphors (hereinafter simply referred to as “phosphors”) M1. The phosphors M1 are various kinds of phosphors that emit light of specific colors when excited by blue light. Examples of the phosphors are listed in the table of FIG. 2. The phosphors M1 partly convert the blue light from the first LED 11 into yellow light LY1 and red light LR1.

Generally, a pseudo-white LED formed by combining a blue LED with various kinds of blue excited phosphors (yellow, green, and red emitting phosphors) achieves a conversion efficiency of about 30% to convert blue light into white light. Namely, about 70% of the blue light from the blue LED is outputted as it is without converted. Blue light that is emitted from the first LED 11 and is not converted by the first phosphor layer 12, i.e., the blue light that makes no reaction with the phosphors M1 in the first phosphor layer 12 is outputted as it is as blue light LB1 from the output face 100 of the first light source 10. Accordingly, first output light L1 from the first light source 10 includes the blue light LB1, green light LG1, yellow light LY1, and red light LR1.

On the other hand, the blue light emitted from the second LED 21 passes through the second phosphor layer 22 and filter layer 23 and goes outside an output face 200 of the second light source 20. The second phosphor layer 22 is made of resin containing the blue excited phosphors (hereinafter simply referred to as “phosphors”) M2. Phosphors that are adoptable for the phosphors M2 are similar to those adoptable for the phosphors Ml listed in the table of FIG. 2. The phosphors M2 partly convert the blue light from the second LED 21 into green light LG2, yellow light LY2, and red light LR2, which are outputted from the output face 200 of the second light source 20. Blue light from the second LED 21 not converted by the phosphors M2 is partly blocked by the filter layer 23, and the remnant is outputted as blue light LB2 from the output face 200. Accordingly, second output light L2 from the second light source 20 includes the blue light LB2, green light LG2, yellow light LY2, and red light LR2.

As mentioned above, the filter layer 23 partly absorbs or reflects the blue light that is emitted from the second LED 21 and transmitted through the second phosphor layer 22 without converted by the phosphors M2, i.e., without reacting with the phosphors M2 in the second phosphor layer 22. The filter layer 23 may be made of blue-light-absorbing resin, or resin mixed with blue-light-absorbing dye, or a material that reflects only blue light.

Although the first embodiment of FIG. 1 arranges the filter layer 23 on the second phosphor layer 22 of the second light source 20, the filter layer 23 may be arranged inside the second phosphor layer 22. In this case, the filter layer 23 must be arranged above the phosphors M2 so that the filter layer 23 may not hinder the blue light converting function of the second phosphor layer 22.

Between light wavelengths and a human biological rhythm, there are the following known facts:

(1) light having a wavelength of around 460 nm suppresses melatonin secretion;

(2) at awakening, melatonin secretion is low;

(3) a large amount of melatonin is secreted about two hours before sleep in the night up to the first half of sleep, to decrease body temperature and induce sleep; and

(4) light irradiation before sleep disturbs the biological rhythm.

FIG. 3 illustrates the emission spectrum characteristics of an incandescent bulb, a fluorescent lamp, and a pseudo-white LED. Compared with the incandescent bulb Sa and fluorescent lamp Sb, the pseudo-white LED Sc has an intensity peak around a wavelength of 460 nm as encircled in FIG. 3. This is because, as mentioned above, the pseudo-white LED demonstrates a conversion efficiency of about 30% when converting blue light into white light and about 70% of the blue light makes no reaction with phosphors.

In this way, many pseudo-white LEDs have an intensity peak around a wavelength of 460 nm, and therefore, are not appropriate for nighttime illumination. Under light having a wavelength of around 460 nm, a person decreases his or her visibility to disturb the biological rhythm without sensing it. It is understood from FIG. 3 that the pseudo-white LED causes a large disturbance in the human biological rhythm and the incandescent bulb and fluorescent lamp demonstrate a similar disturbance level. Introduction of LED illumination for energy saving or for environmental protection may, therefore, sometimes lead to disturbing the human biological rhythm.

As mentioned above, blue light that does not react with the phosphors M1 in the first phosphor layer 12 is outputted from the output face 100 of the first light source 10. Namely, the first output light L1 has an intensity peak around a wavelength of 460 nm. The first light source 10, therefore, is appropriate for daytime illumination and is inappropriate for nighttime illumination.

On the other hand, the second light source 20 has the filter layer 23 that partly blocks blue light emitted from the second LED 21 and transmitted through the second phosphor layer 22 without reacting with the phosphors M2 in the second phosphor layer 22. If the blue light emitted from the second LED 21 and transmitted through the second phosphor layer 22 has the emission spectrum characteristic Sc illustrated in FIG. 3, about 50% of the blue light transmitted through the second phosphor layer 22 is absorbed or reflected by the filter layer 23. As a result, the emission spectrum characteristic of the second output light L2 becomes flat without an intensity peak around a wavelength of 460 nm. A blue light blocking level of the filter layer 23 is determined according to an intensity of the blue light transmitted through the second phosphor layer 22.

The second output light L2 from the output face 200 of the second light source 20, therefore, has less blue light compared with the first output light L1 from the output face 100 of the first light source 10. Namely, the first output light L1 and second output light L2 have different emission spectrum characteristics.

The first output light L1 and second output light L2, however, have an equivalent color temperature (chromaticity) . The first output light L1 and second output light L2 are set to have a general color rendering index Ra of 80 or higher. For example, more green emitting phosphors are contained in the second phosphor layer 22 than in the first phosphor layer 12, and in addition, the plural kinds of phosphors contained in the second phosphor layer 22 are properly combined, thereby equalizing the color temperatures of the first and second output light L1 and L2 with each other. Putting many green emitting phosphors in the second phosphor layer 22 results in equalizing the color rendering index of the second output light L2 with that of the first output light L1 and preventing the color temperature of the second output light L2 from decreasing.

This prevents a phenomenon that the second output light L2 becomes reddish, which may occur if blue light is simply reduced. According to the embodiment, the blue light LB1 contained in the first output light L1 is strong and the blue light LB2 contained in the second output light L2 is weak. However, the second output light L2 contains more green light LG2. Namely, the second output light L2 has an emission spectrum characteristic that the blue light is weaker and the green light is stronger compared with the first output light L1.

The illuminating apparatus 1 having the first and second light sources 10 and 20 according to the first embodiment positively controls the melatonin secretion of a human body as mentioned below, to simultaneously realize comfortable awakening and sleep.

As illustrated in FIG. 1, the illuminating apparatus 1 has a controller 40 to control the brightness of the first output light L1 from the first light source 10 and the brightness of the second output light L2 from the second light source 20. For example, the controller 40 controls a voltage applied to the negative electrode 101 and positive electrode 102 of the first LED 11 and a voltage applied to the negative voltage 201 and positive voltage 202 of the second LED 21, to individually adjust drive currents supplied to the first and second LEDs 11 and 21. The controller 40 thereby separately controls the brightness of the first output light L1 and the brightness of the second output light L2.

In the morning and during daytime, the controller 40 increases the brightness of the first output light L1 from the first light source 10 and decreases the brightness of the second output light L2 from the second light source 20. Blue light containing in the total output light from the illuminating apparatus 1 is increased by setting a condition as defined by a relationship of brightness of L1>brightness of L2. If the total brightness of the illuminating apparatus 1 is 100, the brightness of the first output light L1 is set to, for example, 60 to 100 and that of the second output light L2 to 40 to 0. This setting positively suppresses melatonin secretion and accelerates awakening.

During nighttime, before sleep, or during sleep, the controller 40 decreases the brightness of the first output light L1 and increases the brightness of the second output light L2. Blue light contained in the total output light of the illuminating apparatus 1 by setting a condition as defined by a relationship of brightness of L1<brightness of L2. If the total brightness of the illuminating apparatus 1 is 100, the brightness of the first output light L1 is set to, for example, 0 to 40 and that of the second output light L2 to 100 to 60. This setting causes no prevention of melatonin secretion and induces comfortable sleep.

The illuminating apparatus 1 illustrated in FIG. 1 uses the controller 40 to automatically or manually change the brightness of the first and second output light L1 and L2. When automatically changing the brightness of the first and second output light L1 and L2, the controller 40 may continuously change the brightness, to gradually or rapidly change the brightness for awakening in the morning, normal living during daytime, and before or during sleep during nighttime, thereby positively control awakening and sleep.

FIG. 4 is a graph illustrating an example of continuously changing the brightness of the first and second output light L1 and L2. As illustrated in FIG. 4, the brightness of the first and second output light L1 and L2 is controlled depending on awakening in the morning, normal living during daytime, before sleep, just before sleep, and during sleep in the night, thereby controlling melatonin secretion according to living. During daytime from awakening, the brightness of the first output light L1 is increased and that of the second output light L2 is decreased, to suppress melatonin secretion. During nighttime and just before sleep, the brightness of the first output light L1 is decreased and that of the second output light L2 is increased, to allow melatonin secretion. During sleep, the brightness of the first and second output light L1 and L2 is zeroed. Controlling the brightness of the illuminating apparatus 1 in such a way realizes good awakening and induces proper sleep.

As illustrated in FIG. 4, the brightness of the first and second output light L1 and L2 is periodically changed such that the brightness of one light is decreased when the brightness of the other is increased. This periodical control is achieved by the controller 40 with the use of a program based on, for example, a human circadian rhythm. This realizes the illuminating apparatus and illuminating apparatus controlling method taking into account the melatonin secretion and circadian rhythm.

As explained above, the emission spectrum characteristics of the first and second output light L1 and L2 differ from each other. The first and second output light L1 and L2 have the same color temperature because the material and composition of the phosphors contained in the first and second phosphor layers 12 and 22 are so adjusted. When the brightness of the first and second output light L1 and L2 is changed, no sensible change occurs in color temperature, and therefore, substantially no unpleasantness is felt.

The general color rendering index Ra of each of the first and second light sources 10 and 20 is set to 80 or over, to provide the illuminating apparatus 1 with an excellent object color recognition characteristic.

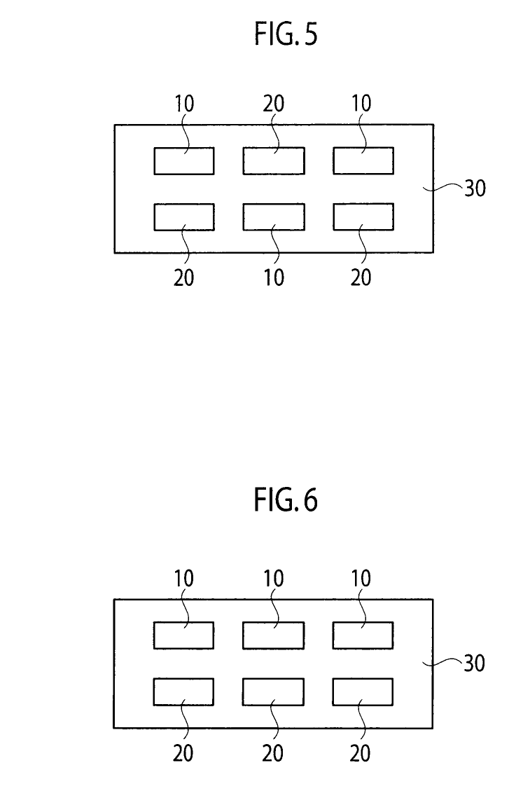

FIGS. 5 and 6 illustrate examples of arrangement of the first and second light sources 10 and 20 on the board 30. In FIGS. 5 and 6, the first and second light sources 10 and 20 are arranged in a matrix of two rows and three columns. Each of FIGS. 5 and 6 is a top view seen in a light output direction. In FIG. 5, the first and second light sources 10 and 20 alternate in row and column directions, and in FIG. 6, the first light sources 10 are arranged in the first row and the second light sources 20 are arranged in the second row. The illuminating apparatus having a plurality of the first and second light sources 10 and 20 is capable of illuminating a wide area.

As explained above, the illuminating apparatus 1 according to the first embodiment of the present invention includes the first light source 10 having a combination of the first LED 11 to emit blue light and the first phosphor layer 12 containing the blue excited phosphors M1 and the second light source 20 having a combination of the second LED 21 to emit blue light and the second phosphor layer 22 containing the blue excited phosphors M2 and the filter layer 23 to partly block blue light. Compared with the first output light L1 from the first light source 10, the second output light L2 from the second light source 20 contains less blue light. The illuminating apparatus 1 individually controls the brightness of the first output light L1 and the brightness of the second output light L2, to positively control the melatonin secretion of a human body. The first and second light sources 10 and 20 each are a pseudo-white LED, and therefore, prevents a reduction in power efficiency compared with the illuminating apparatus according to the related art employing the white LED of RGB configuration.

### Second Embodiment

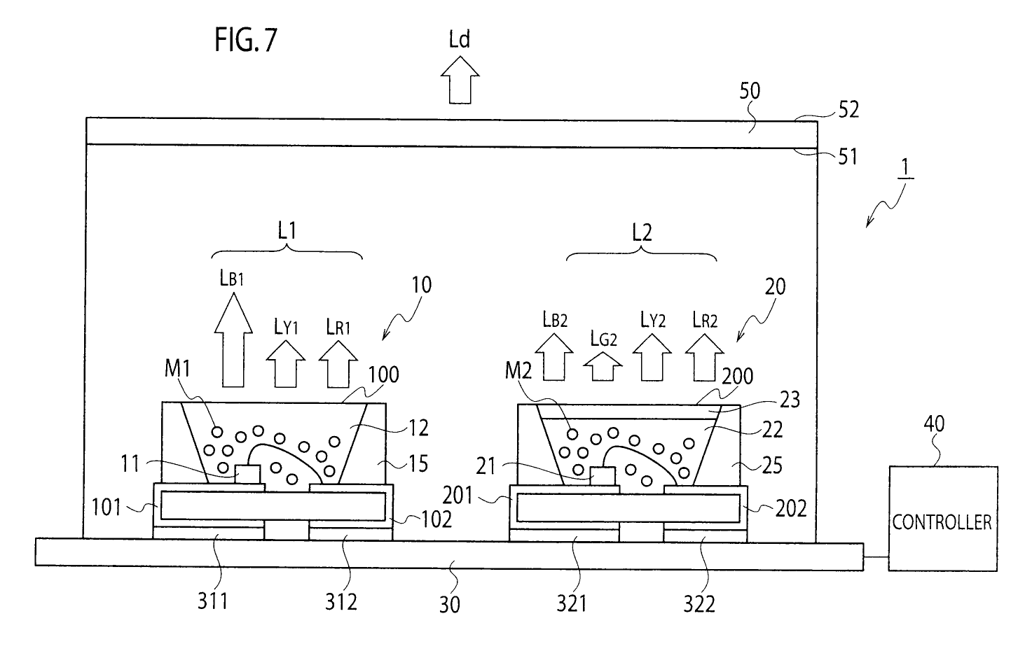

An illuminating apparatus according to the second embodiment of the present invention will be explained with reference to FIG. 7. The illuminating apparatus 1 according to the second embodiment includes a diffuser 50 arranged orthogonal to first output light L1 and second output light L2. The remaining configuration of the illuminating apparatus 1 according to the second embodiment is the same as that of the first embodiment illustrated in FIG. 1.

The diffuser 50 has a first principal face 51 to receive the first and second output light L1 and L2. The first output light L1 and second output light L2 are transmitted through the diffuser 50 and are outputted as output light Ld having equalized brightness from a second principal face 52 of the diffuser 50. When the brightness of the first and second output light L1 and L2 is changed depending on time during a day, the output light Ld from the illuminating apparatus 1 may involve, if there is no diffuser, bright and dark locations or varying bright and dark locations (flickering) to provide users with an uncomfortable feeling. The diffuser 50 of the second embodiment averages such bright and dark locations, thereby minimizing the uncomfortable feeling. The remaining part of the second embodiment is substantially the same as that of the first embodiment, and therefore, is not explained.

Modifications

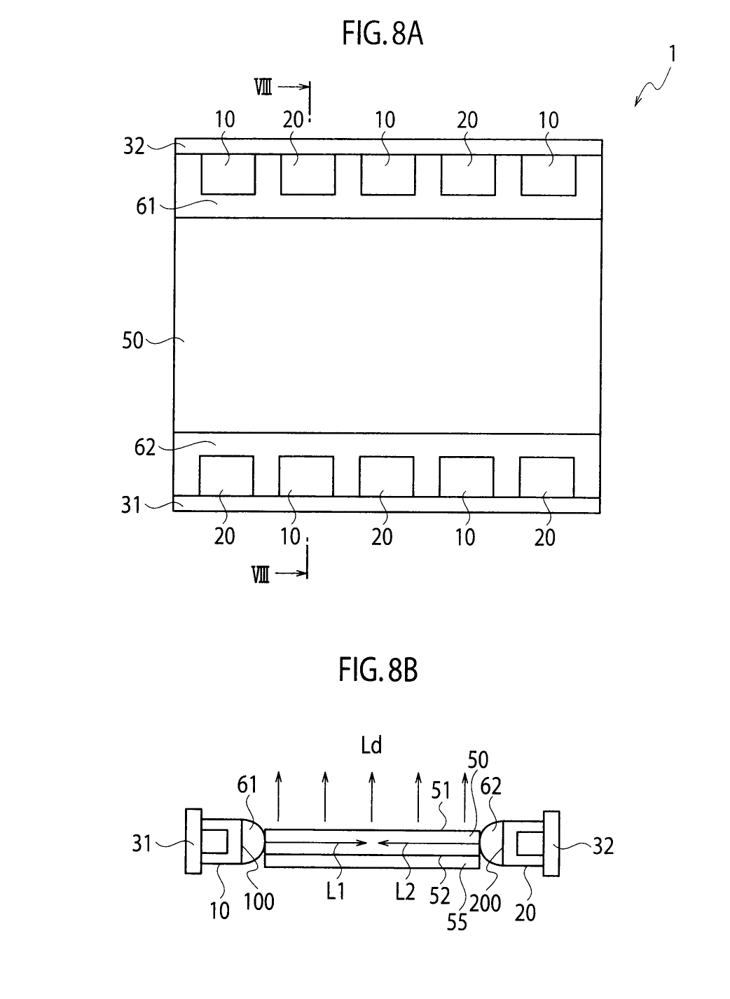

An illuminating apparatus 1 according to a modification of the second embodiment of the present invention will be explained with reference to FIGS. 8A and 8B in which FIG. 8A is a top view seen in the direction of output light Ld of the apparatus 1 and FIG. 8B is a sectional view taken along a line VIII-VIII of FIG. 8A. The second embodiment illustrated in FIG. 7 arranges the diffuser 50 above first and second light sources 10 and 20. On the other hand, the modification illustrated in FIGS. 8A and 8B arranges first and second light sources 10 and 20 along side faces of the diffuser 50.

In FIG. 8A, the first and second light sources 10 and 20 are alternately arranged on each of first and second boards 31 and 32. As illustrated in FIGS. 8A and 8B, it is preferable to arrange the first and second light sources 10 and 20 so that they face each other with the diffuser 50 interposed between them. First output light L1 and second output light L2 are made incident to each side face of the diffuser 50, are diffused in the diffuser 50, and are outputted from a first principal face 51 of the diffuser 50.

As illustrated in FIG. 8B, a reflector 55 may be arranged on a second principal face 52 of the diffuser 50, to reflect the first and second output light L1 and L2. This improves the brightness of the output light Ld from the first principal face 51 of the diffuser 50. The reflector 55 on the second principal face 52 of the diffuser 50 may be omitted, so that the output light Ld may be emitted from both the first and second principal faces 51 and 52 of the diffuser 50.

An output face 100 of the first light source 10 maybe provided with a lens 61 and an output face 200 of the second light source 20 may be provided with a lens 62. The lenses 61 and 62 condense the first output light L1 and second output light L2 to each side face of the diffuser 50.

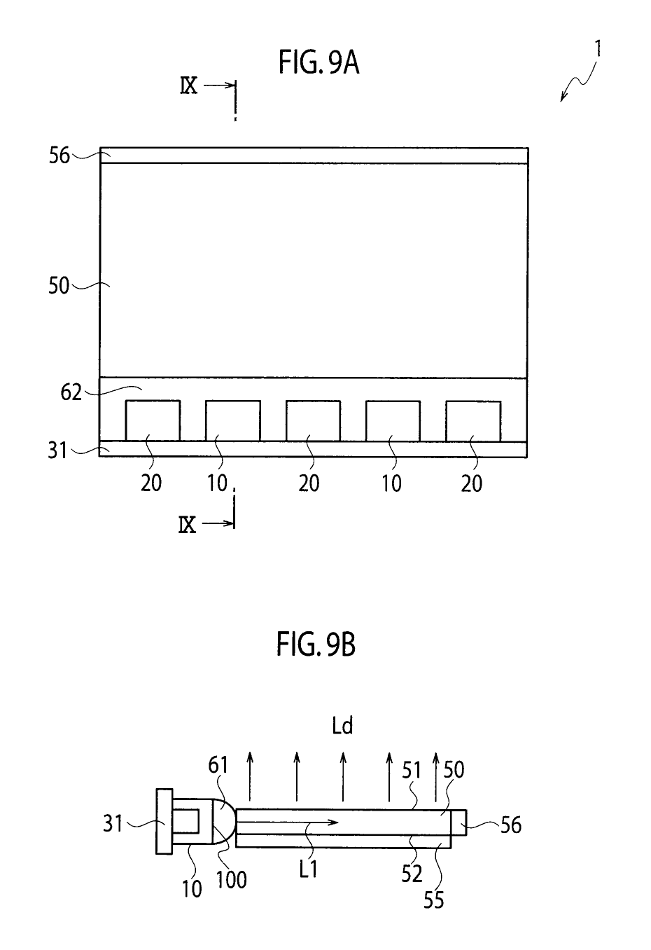

An illuminating apparatus 1 according to another modification of the second embodiment will be explained with reference to FIGS. 9A and 9B in which FIG. 9A is a top view seen in the direction of output light Ld from the illuminating apparatus 1 and FIG. 9B is a sectional view taken along a line IX-IX of FIG. 9A. This modification arranges first and second light sources 10 and 20 along one side face of a diffuser 50. First and second output light L1 and L2 from the first and second light sources 10 and 20 attenuate in the diffuser 50 and mostly do not reach the other side face of the diffuser 50. However, a reflector 56 may be arranged on a side face of the diffuser 50 opposite to the side face into which the first and second output light L1 and L2 are made incident, so that the reflector 56 may reflect the first and second output light L1 and L2.

The illuminating apparatus 1 according to the second embodiment (including the modifications thereof) of the present invention is capable of positively control the melatonin secretion of a human body and reducing, with the use of the diffuser 50, an uncomfortable feeling that may be sensed by users due to bright and dark locations or varying bright and dark locations appearing on the illuminating apparatus 1 if the diffuser 50 is not provided for the apparatus 1.

Other Embodiments

Although the present invention has been explained in connection with the first and second embodiments (including the modifications thereof), it must be understood that the embodiments and the accompanying drawings are not intended to restrict the present invention. As is apparent for those skilled in the art, other embodiments, modifications, alterations, and utilizing forms will be possible from the teachings of the disclosure of the present invention.

For example, the first and second embodiments employ the controller 40 to control the brightness of the first output light L1 from the first light source 10 and the brightness of the second output light L2 from the second light source 20. Instead, the brightness of the first and second output light L1 and L2 may manually be controlled without using the controller 40.

In this way, the present invention covers various embodiments that are not mentioned herein. It must be noted, therefore, that the technical scope of the present invention is defined with reference to the appended claims.

As mentioned above, the illuminating apparatus and the illuminating apparatus controlling method according to the present invention are capable of controlling the melatonin secretion of a human body and securing power efficiency.

This application claims benefit of priority under 35USC §119 to Japanese Patent Application No. 2010-130140, filed on Jun. 7, 2010, the entire contents of which are incorporated by reference herein.

What is claimed is:

1. An illuminating apparatus comprising:
a first light source configured to output white light, having a first light emitting diode emitting blue light and a first phosphor layer containing blue excited phosphors that emit light when excited by the blue light from the first light emitting diode; and
a second light source configured to output white light, having a second light emitting diode emitting blue light, a second phosphor layer containing blue excited phosphors that emit light when excited by the blue light from the second light emitting diode, and a filter layer configured to partly block blue light that is emitted from the second light emitting diode and is transmitted through the second phosphor layer.

2. The illuminating apparatus of claim 1, further comprising
a controller configured to control brightness of the output light from the first light source and brightness of the output light from the second light source.

3. The illuminating apparatus of claim 2, wherein
the controller controls the first and second light sources such that, the brightness of the output light from one of the first and second light source is decreased as the brightness of the output light from the other is increased.

4. The illuminating apparatus of claim 1, wherein
the output light from the second light source has an emission spectrum characteristic that the output light from the second light source contains less blue light and more green light than the output light from the first light source.

5. The illuminating apparatus of claim 4, wherein
the second phosphor layer contains more green emitting phosphors than the first phosphor layer.

6. The illuminating apparatus of claim 1, further comprising
a diffuser configured to receive the output light from the first and second light sources, diffuse the received light, and output the diffused light.

7. The illuminating apparatus of claim 6, wherein
the output light from the first and second light sources is received by a first principal face of the diffuser and the output light diffused in the diffuser is outputted from a second principal face of the diffuser.

8. The illuminating apparatus of claim 6, wherein
the output light from the first and second light sources is received by side faces of the diffuser and the output light diffused in the diffuser is outputted from the first and second principal faces of the diffuser.

9. The illuminating apparatus of claim 8, further comprising
a reflector arranged on one of the first and second principal faces of the diffuser and configured to reflect the output light from the first and second light sources so that the output light diffused in the diffuser is outputted from the other of the first and second principal faces of the diffuser.

10. The illuminating apparatus of claim 8 , further comprising
a lens arranged on an output side of each of the first and second light sources and configured to condense the output light from the first and second light sources to the side faces of the diffuser.

11. A method of controlling an illuminating apparatus that includes a first light source of white light having a first light emitting diode to emit blue light and a first phosphor layer containing blue excited phosphors that emit light when excited by the blue light from the first light emitting diode and
a second light source configured to output white light and having a second light emitting diode to emit blue light, a second phosphor layer containing blue excited phosphors that emit light when excited by the blue light from the second light emitting diode, and a filter layer to partly block blue light that is emitted from the second light emitting diode and is transmitted through the second phosphor layer, the method comprising
controlling the first and second light sources such that, brightness of the output light from one of the first and second light source is decreased as brightness of the output light from the other is increased.

12. The method of claim 11, further comprising
periodically controlling brightness of the output light from the first and second light sources.
